(19) United States
(12) Patent Application Publication
(10) Pub. No.: US 2004/0046789 A1
(43) Pub. Date: Mar. 11, 2004

(54) Extensible user interface (XUI) framework and development environment

(76) Inventor: Angelo Inanoria, San Jose, CA (US)

Correspondence Address: LEIGHTON K. CHONG, OSTRAGER CHONG & FLAHERTY (HAWAII), 841 BISHOP STREET, SUITE 1200, HONOLULU, HI, 96813, US

(21) Appl. No.: 10/641,744

(22) Filed: Aug. 14, 2003

Related U.S. Application Data
(60) Provisional application No. 60/405,511, filed on Aug. 23, 2002.

(51) Int. Cl. G09G 5/00

(52) U.S. Cl. 345/748

(57) ABSTRACT

A web application development environment and method employs an extensible user interface (XUI) Framework for creating GUI-managing components written in a declarative format for handling GUI components in a web application. The GUI-managing components are coordinated in a view presentation layer by a Controller in an Extended-Model-View-Controller (XMVC) pattern in conjunction with the business logic layer. The Controller is invoked by a user request for a web page and in turn invokes the GUI-managing components to parse information contained in a corresponding web application file for the requested web page in order to determine the templates and sub-templates to be invoked for handling the GUI components. Each template has a mode value which is set by mode information contained in the web application file for the requested web page. The XUI Framework has the ability to handle a rich set of GUI components without having to implement web applications development technologies. Instead, the declarative-formatted GUI components can be created and processed using lightweight technologies for client-side and server-side processing. The XUI Framework allows for the efficient authoring and processing of GUI components for a wide range of web applications.

### SPECIFICATION

This U.S. Patent Application claims the benefit of the priority filing date of U.S. Provisional Application No. 60/405,511 filed on Aug. 23, 2002, entitled “Extensible User Interface Framework and Development Environment” by the same inventor.

### FIELD OF INVENTION

This invention pertains generally to tools for creating a graphical user interface (GUI) for web applications, and more particularly, but not limited to, a structural framework for and authoring, processing and rendering of modular and extensible web browser GUIs providing rich, visual interfaces normally found and experienced in desktop software applications.

### BACKGROUND OF THE INVENTION

When creating a web application, it has become a necessity to employ a flexible framework for building and displaying a graphical user interface (GUI), and it has also become a necessity to create rich sets of GUI elements and components to deliver an engaging user experience for a given web application. Desktop application software with rich GUIs are desired in terms of usability and user experience promoted by an advanced user interaction model where components support a vast array of dynamic controls and event handling through the user's input.

Desktop application software have become standardized around certain well-recognized “look-and-feel” appearances that allow users to intuitively learn the GUI controls for different applications, even when encountering a new application. In order for web applications to appeal to a broad base of users, it is necessary to have a development environment that supports the creation of GUI components that provide a consistent appearance in the user interface to users by emulating the look-and-feel of standard windowing environments such as, but not limited to, Microsoft Windows(TM), Motif(TM), and Apple Macintosh(TM).

On the other hand, the user interface for web applications having a set of hypermedia documents as its primary asset is commonly designed to be “destination-oriented” where each of these documents are linked via hyper-linking, and users can navigate from one page to another until he or she has found the desired page. This is in sharp contrast with the conventional desktop applications where the user interface is designed to be “task-oriented” where users click on buttons to open dialog boxes or click the menubar to see other parts of the application or to perform another or different task, etc. In recent years, the limitations of current web application development environments, in terms of delivering rich GUIs that can be intuitively interacted with by users, has proven to be the biggest business and technical issue for anyone wishing to implement a web application.

With the standard web browser as the main tool to access hypermedia documents and other remote assets on the Internet, it has become desirable to deliver complex web applications with a standard look and feel, as has been the case with stand-alone, “shrink-wrapped” software programs. However, conventional development environments for websites are weighted toward the web application's business logic and assets residing on the server-side, rather than on the user interface on the client-side. The lack of a consistent and standardized process in building user interfaces for web applications contributes to the lack of consistency between different applications, in contrast to the standardized look-and-feel of GUIs normally employed in desktop applications. Thus, conventional development environments for creating and implementing user interfaces for web applications have proven largely ineffective in delivering consistent and easily usable interfaces for users regardless of the application's complexity.

A conventional approach to delivering rich GUIs for web applications is through the use of comprehensive (heavyweight) development environments such as Java Swing(TM) for Sun Microsystems' Java environment, AWT(TM), or the Microsoft environment for creating ActiveX(TM) components. This approach has proven to be ineffective as well since it takes away from the natural ability of the Web to deliver content and other media to a variety of clients having different protocols, processing capabilities, or policies from supporting such heavyweight technologies. There have also been numerous known issues in creating GUIs in Java applets. Some ISPs and vendors even ban the use of GUIs written as Java applets.

The typical process of creating GUI components for a web page is done through HTML, JavaScript, CSS, etc. separately, and then importing them into a developed application through typical “include” statements or linking mechanisms. GUI data is normally bound or coupled with the GUI logic which normally makes the reuse of these GUI objects very difficult especially when working with multi-behavioral or multi-modal pages. One attempt to overcome these issues is disclosed, for example, in published U.S. Patent Application No. 2002/0085020, of Carroll, Thomas J. Jr., entitled “XML-based Graphical User Interface Application Development Toolkit”, which describes an approach to segregate the development of the user interface from the development of the underlying application logic (“business model”). The application's graphical user interface is specified using an XML document as an application interface file. At the application's compile time, this application interface file is parsed, and the specifications therein are used to retrieve graphical screen components from an interface library to create the user interface (“view”). This approach of separating the development of then later processing interface generation in coordination with the business logic is commonly referred to as the MVC (Model-View-Controller) approach. However, the MVC approach has shortcomings in that developers are limited in composing UI components per request, and can exhibit polymorphic behavior with only limited flexibility.

### SUMMARY OF THE INVENTION

The present invention seeks to overcome the issues, inefficiencies, and limitations mentioned above, as well as to enhance the development environment for web application GUIs and the usability of web applications and user experience for end users. In particular, the present invention seeks to provide a development environment for web applications that can utilize standards-based lightweight technologies, rather than heavyweight GUI processing technologies.

1. In accordance with the present invention, a web applications development environment and method employs an extensible user interface (XUI) framework for developing modular and extensible GUI-managing components residing in a view presentation layer separate from a business logic layer for a given web application, wherein the GUI-managing components are written in simple declarative format referencing predefined templates to be invoked for handling GUI components to be incorporated in a view of a requested web page. The functions of the GUI-managing components are coordinated in the view presentation layer by an XMVC Controller in an Extended-Model-View-Controller (XMVC) pattern of operation in conjunction with application data provided by the business logic layer. The GUI-managing components parse information contained in a corresponding web application file for the requested web page in order to determine the templates and sub-templates thereof to be invoked for handling GUI components in the view presentation layer. The Controller invokes the GUI-managing components by importing respective templates and sub-templates thereof, wherein each template has a mode value which is set by mode information contained in the web application file for the requested web page.

The XUI framework employs reusable and extendable or extensible user interface (UI) content objects that can be invoked by the GUI-managing components to exhibit polymorphic behavior. The GUI-managing components are formulated in simple XML, XSL, DHTML, XHTML, and HTML statements, which can readily be handled by JavaScript and CSS for client-side processing, and XML technologies and Java Technologies for server-side processing.

The XUI framework avoids using heavyweight technologies such as Java Swing and AWT to render GUI components due to the inherent nature of these to use up large amount of computing resources, particularly memory. For Java to render an applet window, it needs to make use of a Java Virtual Machine (JVM) loaded in the user's machine. This also means that the web application running as an applet may also run outside of the web browser realm. Although use of Java applets has become prevalent, it remains an issue when applets need to be used for a given web application, and security is still in question when running Java applets. On the other hand, web applications using technologies native to web browsers tend to be a more welcomed alternative. For instance, native HTML, JavaScript, CSS have proven themselves to be “harmless” when running in the client's browser and relatively simple to deploy in comparison to Java applets. Although the inherent capabilities of such mentioned technologies are very limited for creating rich GUIs, the present invention extends the capabilities of such lightweight technologies to be used for rich GUIs even in complex web applications.

In a preferred embodiment, the present invention includes systems, methods, and conventions which allow the creation of GUIs that have a “deliberate kinship” to or consistency with existing GUI development environments and tools such as Java Swing and AWT. In order to bring consistency between the development of the web application's user interface and the traditional software user interface, and so that the same efficiency, flexibility and ease of development is achieved, “deliberate kinship” is applied to emulate the techniques, patterns, conventions and standards found in the conventional development environment for Java Swing and AWT components. Deliberate kinship means the present invention and its preferred embodiment closely mimic and emulate, for example, the creation of a Swing Menu Tree component in Java or the creation of MFC Windows components of Microsoft. The present invention's extensible GUI components thus include familiar windows, split-pane windows, menu bars, tree menus and toolbars, etc., as used in standard windowing systems. This gives the ability for the given web application to be rendered with the look-and-feel familiar to a broad base of users.

The preferred embodiment provides for creating a XUI framework using XML with Object Oriented (OO) behavior. Traditionally, XML is designed to be a declarative and procedural language. By way of organizing the pattern of communication between XML documents, schemas or DTDs, and XSL templates in a hierarchical form, OO behavior is achieved, thus producing a more robust architecture and framework with modular and reusable elements.

The present invention allows rich GUIs to be efficiently and readily developed to produce a similar user experience as found in conventional client or desktop applications, while providing a huge improvement in performance, flexibility, scalability and manageability of the web application, as well as large savings in development cost.

### DESCRIPTION OF THE DRAWINGS

FIG. 1 is a representation of an extensible user interface (XUI) framework for a web application development environment according to the principles of the present invention.

FIG. 2 is a representation of the traditional Model-View-Controller (MVC) pattern.

FIG. 3 is a representation of Extended-Model-View-Controller (XMVC) approach as implemented in the XUI framework in the present invention.

FIG. 4 is a representation of the interaction in the XMVC pattern between the super class and subclasses of templates to produce a polymorphism effect.

FIG. 5 illustrates how the Layout Manager delegates control (through polymorphism) to its sub-templates to execute the layout algorithm.

FIG. 6 illustrates how the Component Manager delegates control (through polymorphism) to its sub-templates to execute the layout algorithm.

FIG. 7 illustrates how the Look-and-Feel Manager delegates control (through polymorphism) to its sub-templates to execute the layout algorithm.

FIG. 8 represents the hierarchical relationship between the XFrame (topmost container of content objects) to the XContentPanel (sole child of the XFrame) and XPanels having content objects embedded in them.

FIG. 9 illustrates the communication of web page parameters by XUIOs to the XMVC Controller for the rendering of UI content objects in accordance with the Layout Manager executing a desired layout algorithm.

FIGS. 10A to 10D illustrate examples of different look-and-feels for GUIs implemented in the XUI framework.

FIG. 11 is a diagram illustrating the logic flow to invoke the Layout Manager.

FIG. 12 is a diagram illustrating the logic flow to invoke the Component Manager.

FIG. 13 is a diagram illustrating the logic flow to invoke the Localized Content Manager.

FIG. 14 is a diagram illustrating the logic flow to invoke the Look-and-Feel Manager.

FIG. 15 is a diagram illustrating an example of a BorderLayout algorithm for layout presentation regions of a web page as applied by the Layout Manager.

### DETAILED DESCRIPTION OF THE INVENTION

The following detailed description describes a preferred embodiment of the present invention for implementing for an Extensible User Interface (XUI) Framework for a web application development environment. The described embodiment makes use of a specific set of GUI components, which are pre-defined and pre-built using lightweight markup languages such as HTML, XHTML, XML and scripting languages such as JavaScript or JScript and stylesheet language such as CSS. It also makes use of native GUI components of web browsers such as buttons and various form fields so that it is not necessary to recreate GUI components that are already available within the given web browser. The “server-side” calls for parsing and processing XML documents, XSL templates for Transformations and Formatting Objects, XPath, XQuery, XLink and XPointer expressions, and compiling and running Java code in the form of JavaServer Pages or Servlets. The “client-side” pertains generally to a remote client wherein a standard web browser is the requesting agent which is capable of parsing and processing XML documents and XSL templates for Transformations and Formatting Objects, and is capable of running script code written in JavaScript or Jscript, and is capable of rendering style as defined inside a Cascading Style Sheet (CSS) document, and is capable of rendering XHTML or HTML. However, it is to be understood that many other modifications and variations may be made thereto within the spirit and scope of the disclosed principles of the present invention.

Since the beginning of the Web era, the development of an effective and scalable set of GUI has been and remains a challenge. Despite the advancement of web technology, standards, browsers and the proliferation of application frameworks and template engines, the problems and issues inherent to web GUIs continue to plague most web site and web applications development. These inherent issues tend to fall into two fundamental areas: the creation, deployment and management of GUI assets for a heterogeneous client environment; and usability and user experience

Since website GUIs are open to design, there are no specific standards as to how GUI elements should be constructed except for the built-in HTML form elements which are rendered based on the browser's implementation. Even so, a developer may change the appearance of a form element by using CSS. For instance, a button can be made to appear in any available RGB color instead of the default gray color. As an example, to produce an input field for an HTML page, one would code a standard tag such as:

<input type=“text” name=“foo” value=“bar” size=“25”>

The preceding code produces the default form text field output as rendered by a standard browser which is sufficient for building simple UI controls and components. But if one has to create a GUI component such as a multi-leveled Menu Bar having drop-down menus and different sets of icons, one has to create an elaborate set of complex code possibly written in JavaScript or JScript. This approach obviously is not suitable for building applications where GUI components should be reusable and extendable. One possible approach is to pre-build these UI components and make them part of standard libraries where one can use them through “include” mechanisms. For example, to include a JavaScript file, the HTML code could be written as:

<script language=“javascript” src=“myscript.js”>

Once included, the developer can then call a particular function from that file and send that function particular parameters to control the desired output or behavior. This had been the traditional way of creating and reusing UI components for the web, especially any components that are in DHTML which is a combination of JavaScript and CSS. Despite its effectiveness, this approach has proven to be very limited when attempting to have modular and flexible framework for UI components. With this approach, UI data such as labels for a Menu Bar are usually embedded within the scripting language itself, possibly loaded into an Array, and cannot be re-used across a heterogeneous set of client having different implementations of scripting languages depending on the browser version.

One popular and standard approach to creating a scalable application architecture is through the use of the Model-View-Controller (MVC) pattern. The premise of this design is to cleanly separate data, presentation, and business logic. Most application frameworks implement this pattern. In recent years, Object Oriented (OO) programming for web applications has become a staple with the popularity of programming languages such as Java from Sun Microsystems. MVC was originally designed for Smalltalk-80198 where the user interface was created around such framework. Over time, this has been applied as a classic pattern and has gained popularity in web applications architectures. Some of the benefits have a direct impact to the most common non-functional requirements found today in web applications development such as scalability, maintainability of code, and flexibility in integration. But despite the robustness and the efficiency gained in web development when and where this pattern is applied, some limitations, and even deficiencies, have surfaced.

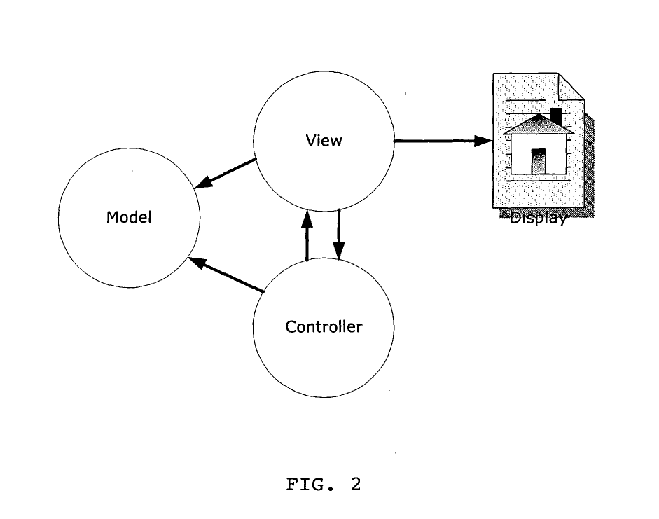

The conventional MVC pattern as illustrated in FIG. 2 is split into three components, i.e., a Model, a View and a Controller object. The separation of data and presentation logic allows the retrieval of application data to be isolated from the view presentation or the user interface, so that changes can be made to the visual appearance of the user interface without disturbing the underlying business logic or data. It is very difficult to manage applications where data and presentation are mixed in one piece of code. In the MVC, the Model represents the application data, which is normally retrieved from an existing database or generated on the fly through some application logic. The View represents the GUI components of the application, which are responsible for displaying visual information to the user. The Controller is responsible for coordination between the Model and the View.

However, the MVC has the following shortcomings when it comes to lower-level GUI design and implementation. When creating views, developers are limited to compose only one UI component per request, which is the whole page itself or “view” (usually the whole HTML page). This one page is normally written in a language such as JSP and employs “includes” to reuse other pre-composed UI components. In OO paradigm, this is considered as composition—one page is composed of many components. Without further control of included UI components, the “view” cannot extend these components to behave differently or to have extended or different set of data when rendered. To add behavior or data to any of the included UI components, the developers need to change the presentation logic inside the UI component's code, possibly using “if-else” or “switch-case” statements. Thus, in MVC, the View component does not support polymorphism. Polymorphism in OOP means an object can have many (“poly”) forms (“morphism”). In UI development, a UI component should have the ability to be rendered in many forms when and if desired. This is accomplished through the use “if-else” or “switch-case” statements in traditional programming which offer only limited flexibility.

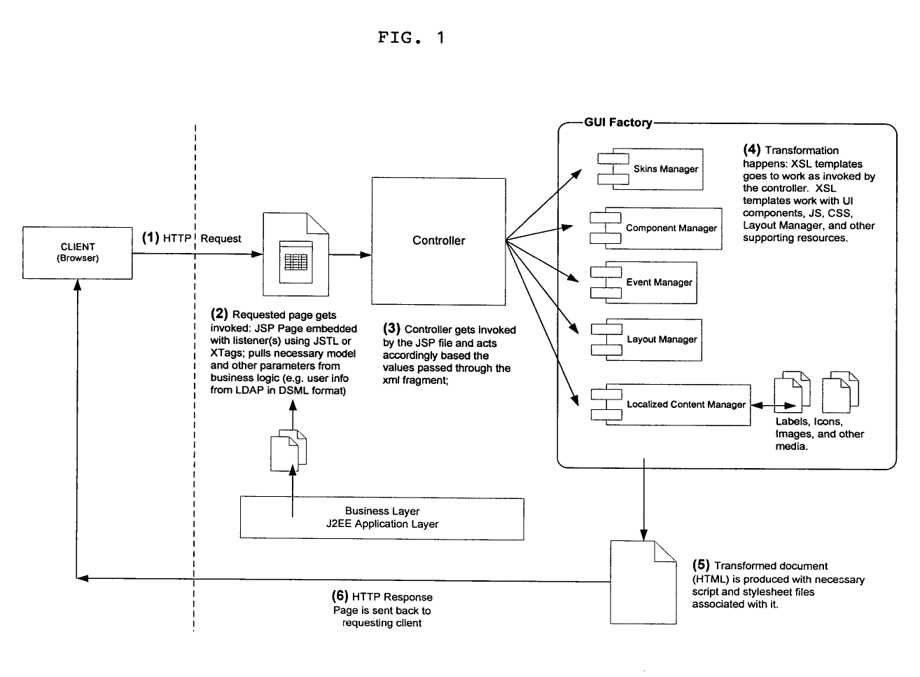

Referring to FIG. 1, the present invention provides an extension to overcome the limitations of the conventional MVC (Model-View-Controller) pattern by using an Extended Model-View-Controller (XMVC) pattern with a more fine-grained division of GUI-managing components. The GUI-managing components invoke predefined templates which are written in simple declarative format to enable the use of lightweight technologies for the development environment. The templates are structured in hierarchical form so that polymorphism is exhibited in the handling of UI content objects. As shown in the figure, when an HTTP request to a given web application is sent by a client user and received on the server side, the requested web page is invoked and processed by the Controller. For example, the requested page may be in the form of a JSP Page (Java Server Page) which is embedded with instances of UI Objects written in XUI API using JSTL, XTags, or other custom tags for application data requested by the user. The application data is retrieved from the business logic (“Business Layer”), for example, it may be user information contained in an LDAP directory in DSML format. The parameters for the view of the requested web page are passed to the XMVC Controller which then delegates generation of the web page view to the GUI-managing components of the XMVC pattern. The application data is incorporated and the responsive web page is sent to the client user where it is finally rendered.

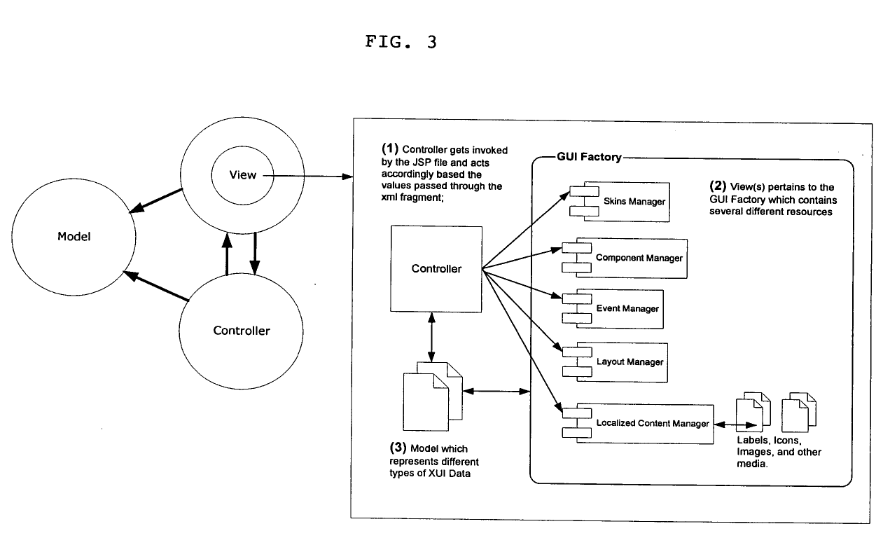

The XMVC Controller coordinates the presentation of a web page view of the application data from the Business Layer with the View to be generated by the GUI-managing components residing in a “GUI Factory”. As illustrated in FIG. 3, the GUI Factory may be composed of the following independent but interacting GUI-managing components:

The Layout Manager is responsible for rendering a view of a web page according to a selected layout algorithm and has its primary responsibility in the positioning and shaping of UI content objects contained in its associated “container”. It is to be understood that the Layout Manager is only responsible for the positioning of the UI component and not its look-and-feel.

The Component Manager is responsible for the organization of different XSL templates for each corresponding supported UI component such as menubars, menutrees, tabbedpanes, etc. The Component Manager is also responsible for the organization of script files and stylesheet files used by each component's XSL template.

The Localized Content Manager (LCM) is responsible for managing and rendering localized content such as labels and images from a database of internationalized labels and images.

The Look-and-Feel Manager is responsible for managing and organizing a pluggable and customizable look-and-feel appearance for a view of a web page. It is also responsible for binding the appropriate stylesheets and scripts that are “plugged” into the final hypermedia document delivered to the requesting client.

The Event Manager is responsible for binding events to the appropriate event handler, methods, and functions as defined by the developer.

XUI Polymorphism

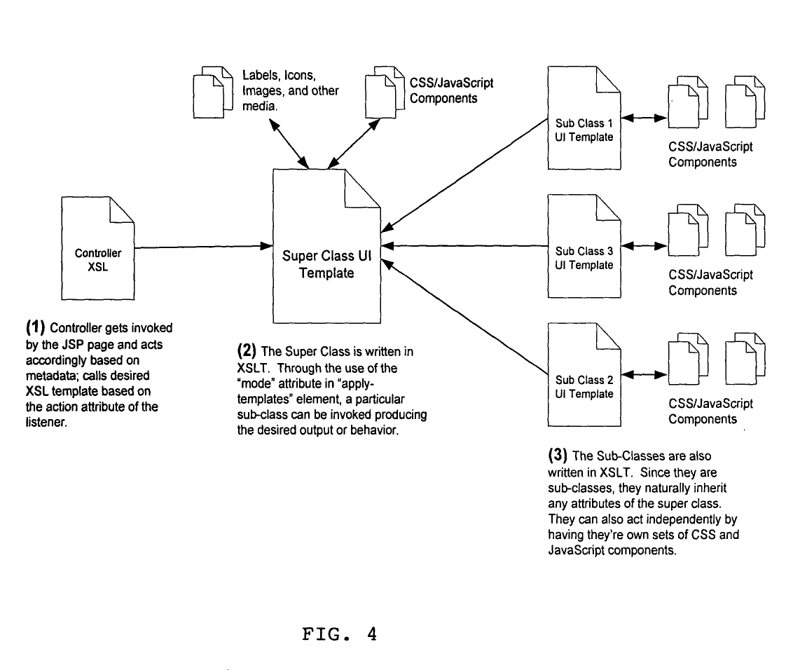

As depicted in FIG. 4, the XUI framework takes advantage of a hierarchical interaction of super class and subclasses of templates to exhibit polymorphism in hypermedia documents and pages with a number of modalities. Polymorphism is the ability for classes to provide different implementations of methods that are called by the same name. Polymorphism allows a method of a class to be called without regard to what specific implementation it provides. For example, a class named Road may call the Drive method of an additional class. The Car class may be SportsCar, or SmallCar, but both would provide the Drive method. Though the implementation of the Drive method would be different between the classes, the Road class would still be able to call it, and it would provide results that would be usable and interpretable by the Road class. With XUI, polymorphism is achieved by leveraging the “mode” attribute in the <xsl:template> element where it can receive and respond depending on what parameters are passed to it.

Multiple classes may implement the same interface (interface polymorphism), and a single class may implement one or more interfaces. Interfaces are essentially definitions of how a class needs to respond. An interface describes the methods, properties, and events that a class needs to implement, and the type of parameters each member needs to receive and return, but leaves the specific implementation of these members up to the implementing class.

Multiple classes may inherit from a single base class (inheritance polymorphism). By inheriting, a class receives all of the methods, properties, and events of the base class in the same implementation as the base class. Additional members can then be implemented as needed, and base members can be overridden to provide different implementations. Note that an inherited class may also implement interfaces—the techniques are not mutually exclusive.

Abstract classes provide elements of both inheritance and interfaces (abstract class polymorphism). An abstract class is a class that cannot be instantiated itself; it must be inherited. Some or all members of the class might be unimplemented, and it is up to the inheriting class to provide that implementation. Members that are implemented might still be overridden, and the inheriting class can still implement addition interfaces or other functionality.

Although the types of polymorphism above apply to OO languages such as Java, XUI's polymorphism falls under the third type. In XUI, the decision as to what template, action, label, or any other component to be invoked is achieved by dynamically loading a value to the “mode” attribute of the xsl:apply-templates element in XSL. Through this dynamic loading, the effect of polymorphism is achieved. The end result is that a particular template will be invoked depending on the value of the “mode” attribute of the xsl:apply-templates element.

XUI Framework

The XUI framework contains pre-built components that facilitate the rapid development of GUI components for web applications by using extensible lightweight widgets. One of the goals of XUI is to provide an environment and development process in implementing these GUI components. The preferred embodiment is intended to work with a client/server environment particularly a web environment where communication is facilitated through a request-respond model utilizing existing communication protocols such as HTTP, HTTPS, FTP, SMTP or even RMI (Remote Method Invocation). It also includes the use of Web Services wherein data and other information that may affect the behavior of the GUI components can come directly from another system outside of the current system. Although the primary target for rendering the rich GUI widgets are web browsers found in desktop computers, the present invention may also be applied to other devices such as Personal Digital Assistants (PDAs) and other portable devices such as a tablet computer capable of running a web browser.

The preferred system is developed in a hybrid format using XML and Java technologies for server side processing and creation of rich GUI components for web-based applications. XML technologies include XML documents, XSLT, XSL-FO, XPath, XQuery, XLink and XPointer. The Java programming language, developed by Sun Microsystems of Mountain View, Calif., is used in the present invention to enhance and support any areas of the framework that needs programming logic where XSL may not be able to handle.

The Extensible Stylesheet Language for Transformation (XSLT, or simply XSL), although powerful, is designed for the efficient transformation of XML documents with the use of the XML Path Language (XPath). XSL is known as a declarative language that carries “no side effects”, meaning that XSL does not employ any mechanism to affect and change the state of different areas of a stylesheet through assignment operations. XSL does not have assignment operations where variables can change values through the logic process. Thus, XSL at times can be limiting when a certain effect needs to be achieved within the system. This is where the Java programming language is used with its strong Object Oriented programming capabilities.

Server-side processing includes the handling of the client request and then properly creating the final hypermedia document in the form of an HTML page embedded with the appropriate JavaScript, XML fragment and CSS files to be returned to the requesting client. The client, which is mainly a web browser, then takes the processed HTML, JavaScript, XML and CSS files and renders the document to be viewed by the end user.

The XUI framework is designed to facilitate the creation and delivery of hypermedia documents for web applications with rich familiar GUI components such as menubars, toolbars, combo boxes, etc. that are typically found in traditional desktop applications. It pertains generally to a web application wherein the graphical user interface (GUI) have the ability to emulate the look-and-feel of standard windowing environments without using heavyweight technologies such as Motif, Microsoft MFC, Java Swing or AWT, but rather using standards-based lightweight technologies such as DHTML, HTML, JavaScript and CSS. XML technologies including XPath and XSL both can be used for server-side and client-side parsing. This feature of the present invention sharply contrasts with the approach represented in the conventional approach, for example, as described in U.S. Patent Application No. 2002/0085020, of Carroll, Thomas J. Jr., entitled “XML-based Graphical User Interface Application Development Toolkit”.

The XUI framework does not rely on any packages, classes or interfaces provided by Java's AWT, Swing, Microsoft Foundation Classes, Motif and other windowing libraries for the creation of rich GUI components but rather employs its own pre-defined and pre-built GUI components by using lightweight markup languages such as HTML, XHTML, XML and scripting languages such as JavaScript or JScript and stylesheet language such as CSS.

Referring again to FIG. 1, the XUI framework is used to create GUI-managing components maintained in the GUI Factory which are used to generate views in the form of hypermedia documents in response to client requests in a web environment with the request-response model. The GUI factory, working with the Controller, contains several parts having their own different tasks in parsing, processing, transforming, and rendering of UI components. These interacting parts are the Layout Manager, Component Manager, Localized Content Manager, Event Manager, and Look-and-Feel Manager.

The XUI framework provides a set of declarative application programming interfaces (APIs) known as Simple API for XUI (SAXUI) to be used as the main programming interface for a developer wishing to create web GUI components using the XUI framework. The current invention provides a set of generalized tags or elements that can be used to create and render rich GUI widgets without requiring the developer to create complex programs using Java or other heavyweight programming language. Pages, or more appropriately, screens are created without concern for platform-specific windowing issues. As mentioned, these GUI widgets are designed to emulate the look-and-feel of GUIs as typically found in desktop applications. The XUI framework facilitates the rapid development of rich GUIs for web applications with a set of consistent and pluggable look-and-feel types typically found in desktop applications. It is also to be understood that the XUI framework is not intended to work solely with a specific platform but can be implemented in any development environment given that the underlying technologies used herein are portable and can be used in any environment.

Although the XUI framework can sit on top of practically any J2EE framework, it is to be understood that the invention is not limited to platforms specifically designed for J2EE framework. For instance, the invention may be similarly used for developing web applications developed in the .NET environment developed by Microsoft Corp. Since the XUI framework resides in the presentation layer, it does not matter what application logic is used in the business layer.

A typical web page is created by putting together predefined HTML tags to achieve the desired look-and-feel of the page. There are also pre-built HTML form components for the creation of input fields, buttons, combo boxes, radio buttons, checkboxes, etc. These components are put together by organizing each one inside the “body” tag and may also be further organized by creating HTML tables where components can reside inside Table Data (TD) cells. When viewed in a browser, the layout of each HTML components heavily depends on the how they are written in the HTML document. By default, tags that are written one after another will be rendered from left to right.

With CSS, additional control is provided by strategically positioning such HTML components by manipulating their x and y coordinates in relation to the whole document. Positioning of these components can be controlled by using the “position” property which can be set to either “static”, “absolute”, “relative” and “fixed”. Positioning can then further be manipulated by setting the “left” and “top” properties which takes values in the form of pixel amount.

With all the predefined HTML tags and possible CSS styles and positioning capabilities available, the capability to create sophisticated and rich GUI clients for web applications is still lacking. When a menu bar with dynamic drop-down menu is needed for a web page, developers will normally create one from scratch or re-use a pre-coded script possibly written in JavaScript, Jscript or VBScript.

The XUI framework with its pre-built extensible containers, components, and Layout Manager employing different layout algorithms, attempts to close this gap. To create a web application window with embedded widgets, the developer takes the following steps:

1. The developer creates a JSP file that will contain the code to call the XUI APIs.

2. When an XUI API, also know as SAXUI, is declared inside the JSP, in context this becomes an XUI Object (XUIO) since when the API is declared, the class of such API is instantiated.

3. The developer creates containers, panels and different GUI components by using SAXUI.

4. The developer only needs to use SAXUI instead of coding in Java or JavaScript to achieve the look-and-feel and behavior of the desired component.

5. The underlying Layout Manager is also utilized by defining the layout algorithm for a selected component namely “xpanel”. Each layout algorithm is encapsulated in each of these defining components.

6. The JSP file is then saved inside the appropriate folder for the web application which is exposed to incoming requests from users' web browsers.

Screens in XUI are created by putting together containers and GUI components to be used by the built-in Layout Manager. This is done by creating a document definition inside a JSP file using XUI APIs (SAXUI). The GUI components come to life by declaring XUIOs (XUI Objects) written in SAXUI that work in conjunction with the Controller. XUIOs act as the intercepting agents that communicate with the Controller, which then delegates rendering control to the Layout Manager. Every component API has an XML Schema document associated with it to provide the rules as to how these elements are to be created. This ensures that developers will be guided as to how a tag should be declared. This ensures consistency between each reusable components and each page and consistency throughout the whole application. In the preferred embodiment, the W3C XML Schema Recommendation 2001 Version 1.0 is used.

A container is a type of component which can contain other components. Using a container, related components can be grouped and treated as a unit having one parent container. A container can be nested with other containers which may also contain other containers and components. Containers are simple components which have limited attributes and have the primary job of holding other components. Each container is given a name by setting a value inside the “name” attribute. By giving a name, each component within that container can now refer to its parent through the given name. A style maybe set at the level of a container that can affect the visual attributes of components it contains. For instance, a background color or pattern maybe set at this level which ultimately affects the visual representation of components within it. An event handler can also be set within a container so that event listeners are able to respond when an even such as mouse over or mouse click is fired within the container.

GUI components include menus, combo box, trees, and so on. In Java, User Interface controls such as buttons, scrollbars, menus, text fields and so on are generally referred to as “components”. As with Java Swing, containers and panels are also of type component. In XUI, the XHTMLFragment is another component which can hold native HTML or XHTML code. Another type of component is the XScript component that can hold custom scripting code written in JavaScript, Jscript or VBScript. Any contents of XHTMLFragment or XScript components are relegated to the client browser for the actual rendering or actual execution of any scripts.

Each container has access to the Layout Manager that is responsible for positioning and organizing the components inside the container. When the page being requested by the client browser is created, the Layout Manager is called upon by the Controller to properly layout the components that reside in the container. Essentially, containers, through the Controller, delegate the job of laying out their components to the Layout Manager. The XUI Layout Manager implements different algorithms for organizing and laying out the components. The developer will decide as to what type of layout is necessary to achieve the desired look of the screen. These settings are then passed to the Layout Manager for further processing. This technique of defining a family of layout algorithms which can be encapsulated within each container is known in Object Orient programming as “Strategy Pattern” (ref. Gamma, Helm, Johnson, Vlissides, Design Patterns, p. 135. Addison-Wesley). XUI employs the same pattern but not through an object oriented programming language such as Java but instead through XML transformation using XSL.

The Layout Manager's main responsibility is to determine the layout of components contained in a container. It can also determine the positioning of a container relative to the top-left corner of the screen or the position of the container in relation to the position of its parent container. Positioning is achieved through the default left-to-right relative positioning or through CSS positioning by determining the x and y coordinates of the component relative to its parent container (relative positioning) or absolute positioning where the x and y coordinates are related to the top-left corner of the screen.

Using predefined GUI components through a declarative API accelerates the development of rich GUI clients for web applications. Instead of creating these widgets from the ground up, APIs enable developers to re-use predefined GUI components and have the ability to repurpose their visual behavior by setting different attributes of each element. These predefined GUI components are written in native XML, XSL with XPath, JavaScript, and CSS. Thus, these predefined GUI components are known to be lightweight since they are not written in Java Swing or AWT to achieve the look-and-feel of an Applet.

These predefined GUI components can be referred to as component “classes” wherein they can be instantiated through the declaration of an XUI component tag and providing the name of the component of choice by setting the “class” attribute of the tag. For example, developers can instantiate a menubar class by declaring <xui:component class=“menubar”/>. Attributes and other properties for each instance of these classes are encapsulated within each instance. Thus, with encapsulation, each of these components can be reused, extended, and shared within a screen without concern for conflict.

As mentioned earlier, the present invention is built with “deliberate kinship” to existing development patterns and standards, such as J2EE or MFC, in order to bring familiarity, ease, and agility in the development of good and effective UI. Deliberate kinship means XUI development closely mimics how one software engineer may approach, for example, the creation of Swing components in Java or the creation of MFC Windows components from Microsoft. XUI's extensible GUI components include familiar windows, split-pane windows, menu bars, tree menus and toolbars. These include, but are not limited to, the following pre-defined components:

XFrame—Top-most container that produces the window. Java Swing component equivalent: JFrame.

XContentPane—A content pane is a basic container that can be used to group contents or other component within one area of the page, which is similar to SPAN or DIV tags.

XPanel—A Panel is a type of a container that can contain other containers and components. A layout algorithm is declared at this level by setting its “layout” attribute. A panel has the ability to control its own UI behavior such as background color and image, borders, etc.

XIFrame—This is the Internal Frame component which is similar to the Frame component; but this component can only appear inside the main Frame component and cannot float outside of it.

XComponent—This component is the top-most class for components and is extended by each component that is instantiated.

XMenubar—Menu bars are dropdown menus with the root items listed from left to right. A menu bar is mostly rendered along the upper edge of the windowpane.

XToolbar—Tool bars are similar to Menu bars. The main difference is that a tool bar generally holds icons or pushbuttons instead of text. This is commonly used to display frequently used tools and is usually rendered underneath the menu bar.

XMenutree—The menu tree is a component used to create expanding and collapsing vertical menus. Each menu node can be clickable and linked to an appropriate target page.

XTabbedPane—A tabbed pane displays a group of components where one component is displayed when one of the pane's tabs is selected.

XSplitPane—A split pane physically separates contents or UI components that are positioned in it. At this time, this container can only contain two components.

XToolTip—The Tool Tip enables authors to add a ToolTip to any element on the page. Authors may control the placement and duration of the ToolTip.

XButton—Unlike the built-in button in an HTML form, the XUI button is capable of rendering images and text within the button. It supports different behaviors of borders such as raised, depressed, or flat.

XIcon—A dynamic icon is a simple component that renders an icon that can change UI state based on events such as mouse over or mouse click.

Creating an XUI Screen

The first step in creating a screen with XUI containers and components is to create the main window. The present invention uses the JavaServer Pages (language) as the “wrapper” language to execute the XUI APIs known as SAXUI. It is however to be understood that using SAXUI can be done with other languages such as ASP. JavaServer Pages perform the same tasks as Java Servlets, but uses different programming paradigm. Java Servlets are created using pure Java programming where syntax follows the Object Oriented Programming paradigm. On the other hand JSPs are created using a declarative syntax similar to coding HTML. JSPs are then converted by the server into servlets and compiled to Java classes automatically. Below is an example of a simple JSP:

<html>
<head><title>My JSP</title></head>
<body>

<%= new String(“Hello World”) %>
</body>
</html>

As shown in the preceding example, the JSP code, identifiable with the opening “<%” and closing “%>” can be seamlessly integrated with HTML code. This makes JSP ideal for creating dynamic hypermedia documents. Servlets on the other hand are ideal for creating highly programmatic content and business logic. In the manner as described above, JSP is the ideal programming wrapper for executing SAXUIs. An example below shows how creating a simple empty frame with JSP and SAXUI.

<%@ taglib uri=“http://www.jway.com/xui-1.0” prefix=“xui” %>
<xui:style outputMethod=“HTML”>

<xframe name=“main” lookandfeel=“MSWindows”>

<xcontentpane>
</xcontentpane>

</xframe>

</xui:style>

In the example above, the xui:style tag is a custom tag with an underlying Java code that contains the logic that makes it possible to pass the contained XML fragment to the default Controller file or another controller file defined and declared by the developer. The XUI code embedded within this tag is passed to Controller for further parsing and transformation.

The Controller file is written in XSL. It does not necessarily parse and transform the passed XML fragment to it, but acts as an intercepting agent so that the appropriate XSL template can be called for a particular transformation need. For example, the XSL template for processing the element named “xframe” will be passed by the Controller to the appropriate template by using the <xsl:apply-template> element. In this particular example, since “xframe” element is always the top-most container for an XUI screen, then the following template call will be applied first:

<xsl:apply-templates match=”/xframe”/>

Furthermore, the XUI framework applies the polymorphism behavior wherein the process of calling the appropriate template to apply the desired modality is achieved by calling templates with the same “match” attribute value but having a particular value for the “mode” attribute of the <xsl:apply-templates> element; a particular template from a plurality of templates with the same match value will be applied based on the “mode” value. The value of the “mode” attribute comes from the “lookandfeel” attribute value of the “xframe” element from the XML fragment being parsed.

A dynamic mode value is passed to a template wherein the dynamic value is either created through an XSL variable or created by using Java extensions in XSL where the value is either pulled from a session variable residing in cache or parsed from the XML fragment being passed to the Controller. The following are examples of how polymorphic behavior is achieved through the use of the dynamic mode:

Example 1: This is calling a JSP file embedded with SAXUIs where xframe's lookandfeel
attribute has a value of “MSWindows”. This value will be passed through the Controller file and to
the Look-and-Feel Manager. Full control is delegated to the Look-and-Feel Manager by the
Controller for the final rendering of the desired look-and-feel.
<%@ taglib uri=“http://www.jway.com/xui-1.0” prefix=“xui” %>
<xui:style outputMethod=“HTML”>

<xframe name=“main” lookandfeel=“MSWindows”>

. . . more code here

</xframe>

</xui:style>

### EXAMPLE 2

This is the Controller XSL being invoked by the JSP file showing that the xui-lookandfeel.xsl is being imported; once this file is imported, the template with the match value of “/xframe” and mode value of “setLookandFeel” can be called from the Controller. In this instance, the template having the mode value of “setLookandFeel” resides inside the “xui-lookandfeel.xsl” file. Each of these templates have a unique mode value so that when the xsl:apply-templates element is executed, it will search through the present templates including all imported templates and invoke the template having the desired mode value. Once this template is called, the rest of the processing is fully delegated to the Look-and-Feel Manager represented by the template having the “setLookandFeel” mode residing inside the file xui-lookandfeel.xsl. The ability of the xsl:apply-templates element to search through the present template and all imported templates is inherent to XSL.

<?xml version=“1.0” encoding=“UTF-8”?>
<xsl:stylesheet version=” 1.0”
xmlns:xsl=“http://www.w3.org/1999/XSL/Transform”
xmlns:fo=“http://www.w3.org/1999/XSL/Format”>
<xsl:import href=“xui-lookandfeel.xsl” />
. . . more xsl imports here
<xsl:template match=“/”>

<xsl:apply-templates match=“/xframe” mode=“setLookandFeel”/>
. . . more xsl code here

</xsl:template>
</xsl:stylesheet>

### EXAMPLE 3

This is the Look-and-Feel Manager which is a separate XSL file named xui-lookandfeel.xsl imported by the Controller XSL (note that once this file is imported into another template, all templates herein are exposed to and can be called by the importing template). In this example, the value of the attribute “lookandfeel”, represented by the XPath expression “/xframe/@lookandfeel”, of the “xframe” element found inside the source document is assigned to the variable named “lookandfeel”. This variable is then passed to the “mode” attribute of the apply-templates element which in turn will call the appropriate template based on the desired mode. If the desired mode is not found, a null-pointer will be returned since the desired resource is not found:

<?xml version=“1.0” encoding=“UTF-8”?>
<xsl:stylesheet version=“1.0”
xmlns:xsl=“http://www.w3.org/1999/XSL/Transform”
xmlns:fo=“http://www.w3.org/1999/XSL/Format”>
<xsl:template match=“/”>

<xsl:variable name=“lookandfeel” select=“/xframe/@lookandfeel”/>
<xsl:apply-templates select=“node ()” mode=“{$lookandfeel}” />

</xsl:template>
<xsl:template match=“node ()” mode=“MSWindows”>

. . .

</xsl:template>
<xsl:template match=“node ()” mode=“Metal”>

. . .

</xsl:template>
<xsl:template match=“node ()” mode=“Motif”>

. . .

</xsl:template>
<xsl:template match=“node ()” mode=“Macintosh”>

. . .

</xsl:template>
. . . more templates here for other look-and-feel
</xsl:stylesheet>

The passing of a “mode” attribute is similar to calling a particular function or method in other programming languages. The difference here is that it is not a named template that is being called and the manner by which the call is made is not through the typical manner of using an “if-else” or “switch-case” programming control; rather, it is done by simply calling the same matched template but dynamically passing a “mode” attribute to it.

In the example above, the appropriate template will be called based on the value of the “lookandfeel” attribute of the “xframe” element represented in the XPath expression “/xframe/@lookandfeel”. Note that the value is being passed to this template from the calling XML fragment. This value is stored into a variable with the same name for consistency purposes named “lookandfeel”. This variable is then used inside the “mode” attribute of the xsl:apply-templates element by using the expression {$lookandfeel} and will process the call based on that value. The end effect is that the appropriate template where its mode value is the same as the mode value of the xsl:apply-templates element will be called.

The Look-and-Feel of screens can also be set to “Auto” wherein the proper “skin” will be rendered by way of checking the platform or environment of the requesting client. In this manner, the GUI will still be consistent across heterogeneous clients, but will have a certain level of customization by rendering a Look-and-Feel consistent to native Look-and-Feel of the given platform. For example, the Look-and-Feel of buttons is different between Microsoft Windows and Macintosh platforms. It will be appropriate if the proper Look-and-Feel of a button will be rendered consistent with the native Look-and-Feel of a button for the given platform.

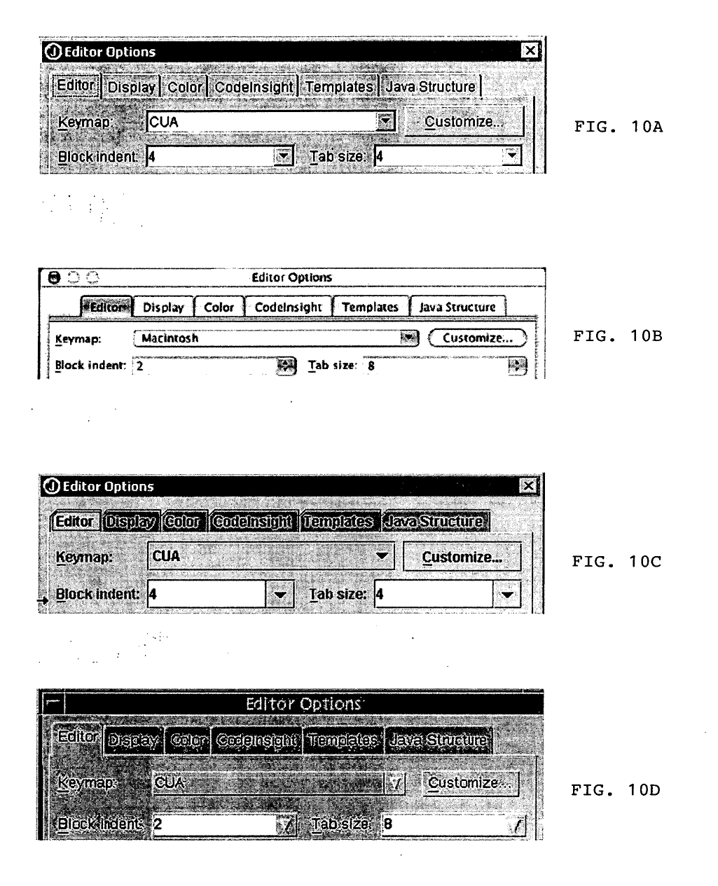

Checking the properties of the requesting client is done by reading the headers of the given request. When a server receives a request from a browser, certain properties of the browser with certain values are available for the server in the form of a header variable. One of the most important headers that are helpful in determining the platform is the USER-AGENT header which contains the browser version information and the Operating System being used by the client. For example, the USER-AGENT header may contain the string: “compatible; MSIE 6.0; Windows NT 5.0” which can then be parsed by the system to determine that the client is using Microsoft Internet Explorer Version 6.0 running on Windows NT version 5.0. With this information, the Look-and-Feel Manager can then acts accordingly and bind the proper set of stylesheets to achieve the desired Look-and-Feel. Examples of web pages rendered to different standards of look-and-feel are shown in FIGS. 10A to 10D.

The following example illustrates how this scenario may work. Notice that the lookandfeel attribute of the xframe element is set to “Auto”. The xframe element also now contains an immediate child element named properties which contains a child element named user-agent. The user-agent element is dynamically loaded with information by using an embedded Java statement that retrieves the User Agent information by using the “request.getHeader( )” method. The combination of the value of the attribute lookandfeel and the value of the user-agent element is then passed to the Look-and-Feel Manager for further parsing and processing.

<%@ taglib uri=“http://www.jway.com/xui-1.0” prefix=“xui” %>
<xui:style outputMethod=“HTML”>

<xframe name=“main” lookandfeel=“Auto”>

<properties>

<user-agent>

<%= request.getHeader (“User-Agent”) %>

</user-agent>

</properties>
. . . more code here

</xframe>

</xui:style>

Given the calling JSP page above, the Look-and-Feel manager will then act based on the combined value of the attribute lookandfeel and the value of the user-agent element. Since a polymorphism pattern is implemented in selecting and executing the proper template, we only need to add another template with the mode value set to “Auto”.

<?xml version=“1.0” encoding=UTF-8”?>
<xsl:stylesheet version=“1.0”
xmlns:xsl=“http://www.w3.org/1999/XSL/Transform”
xmlns:fo=“http://www.w3.org/l999/XSL/Format”>
<xsl:template match=“/”>

<xsl:variable name=“lookandfeel” select=“/xframe/@lookandfeel”/>
<xsl:apply-templates select=“node ()” mode=“{$lookandfeel}” />

</xsl:template>
<xsl:template match=“node ()” mode=“Auto”>

<xsl:choose>

<xsl:when test=“ ”>
</xsl:when>

</xsl:choose>

</xsl:template>
</xsl:template match=“node ()” mode=“MSWindows”>

. . .

</xsl:template>
<xsl:template match=“node ()” mode=“Metal”>

. . .

</xsl:template>
<xsl:template match=“node ()” mode=“Motif”>

. . .

</xsl:template>
<xsl:template match=“node ()” mode=“Macintosh”>

. . .

</xsl:template>
. . . more templates here for other look-and-feel
</xsl:stylesheet>

All XUI screens start with a Frame as the top-most container. A Frame is a type of a container that functions as the main window for any web pages that use XUI components. XUI Frames have attributes such as a title, border, lookandfeel and the default icon of a given web browser and default buttons for maximizing, minimizing and closing the frame. It also supports the usual attributes of a browser window such as: Width, Height, Scrollbars, and Resizable. XUI XFrame also has the additional attributes such as isCentered, Absolute, and isModal.

An XUI Frame or window is created by extending the XUI class XFrame. Since web pages are invoked and loaded within a web browser by accessing a specific URL, an XFrame window is usually created by a predefined script invoked by clicking a link from a loaded page or through some other page event such as “ONLOAD”. From this invocation is where the attributes of XFrame is applied. For example, the width and height of the frame can be set to certain values measured in pixels; the position of the XFrame window can be set to “centered” relative to the four corners of the screen and the center of the XFrame or by x and y coordinates relative to the top left corner of the screen.

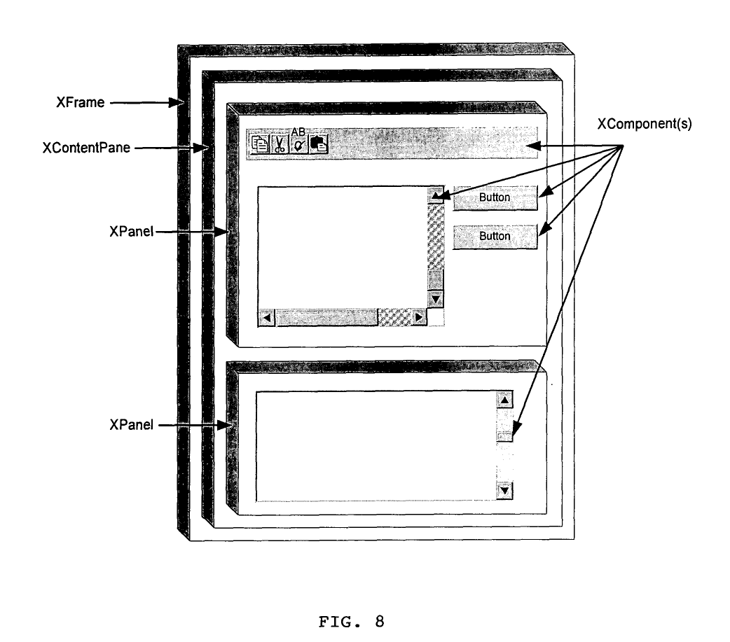

As shown in FIG. 8, a frame contains one type of container, the XContentPane. XContentPane is a top-level container which contains containers called XPanels. XPanels can be nested and can contain other XPanels or they can contain components called XComponents. The ability to nest containers within containers is crucial and a necessity to design screens of much complexity in user interface.

Rendering the Screen

The process in the creation and rendition of the XUI screen begins when a client browser requests a particular address from the server where the web application is residing. The request is intercepted by a web server; and through the typical MIME Type mapping, the request is delegated to another server application which is able to handle a JavaServer Page request. A portion of the Controller is responsible for determining if the requested page should be recreated and delivered to the client or a pre-built page with the same components, look-and-feel, etc. can be retrieved from cache and delivered to the client. Each of the main documents that produce a screen is created in JSP embedded with predefined XUI custom tags. Custom tags are tags created to be part of code library to facilitate the rapid creation of JSP pages without coding in Java. A tag library allows programmers to reuse Java code by reusing tags from the code library. Once built, the code library provides a simple set of custom tags than even non-Java programmers can use.

However, it is to be understood the not all XUI elements and APIs are written as custom tags. From the surface, XUI elements resemble any custom tags and any other declarative languages. XUI elements are pure XML elements which as passed to corresponding XSL templates for processing and transformation. The present invention includes one important tag, the xui:style. This custom tag is used to embed the XUI API elements within it.

<%@ taglib uri=“http://www.jway.com/xui-1.0” prefix=“xui” %>
<xui:style outputMethod=“HTML”>

. . .

</xui:style>

In the preceding example, by creating and using a custom tag named xui:style, any elements within the opening and closing tags will be passed to the XUI Controller for further processing. The xui:style custom tag is written in Java and is invoked whenever the tag is embedded within a JSP page. This custom tag and any other custom tags within of the XUI framework tag library, including all other elements are bound to the namespace: http://www.jway.com/xui-1.0.

The xui:style tag can contain an additional attribute to over-ride the delegation of processing to the default controller file. When the xui:style custom tag's attribute named xsl is not present, the underlying Java code delegates the processing to the default Controller file found inside <APP-HOME>/XUI-INF/conf/ folder. The name of the file is “controller.xsl”. A developer may decide delegate the processing to another controller by simply adding a value to the xsl attribute of this custom tag. For example:

<%@ taglib uri=“http://www.jway.com/xui-1.0” prefix=“xui” %>
<xui:style xsl=“mycontroller.xsl” outputMethod=“HTML”>

. . .

</xui:style>

XUI Controller

The XUI Controller is the intercepting agent which controls the communication within XMVC and sends different parameters and delegates actions to the GUI Factory which contains different communicating parts having distinct responsibilities in rendering the desired GUI. The Controller delegates control to GUI-managing components such as the Layout Manager, the Component Manager, the Localized Content Manager, the Look-and-Feel Manager, the Event Manager, and other resources such as repositories and databases.

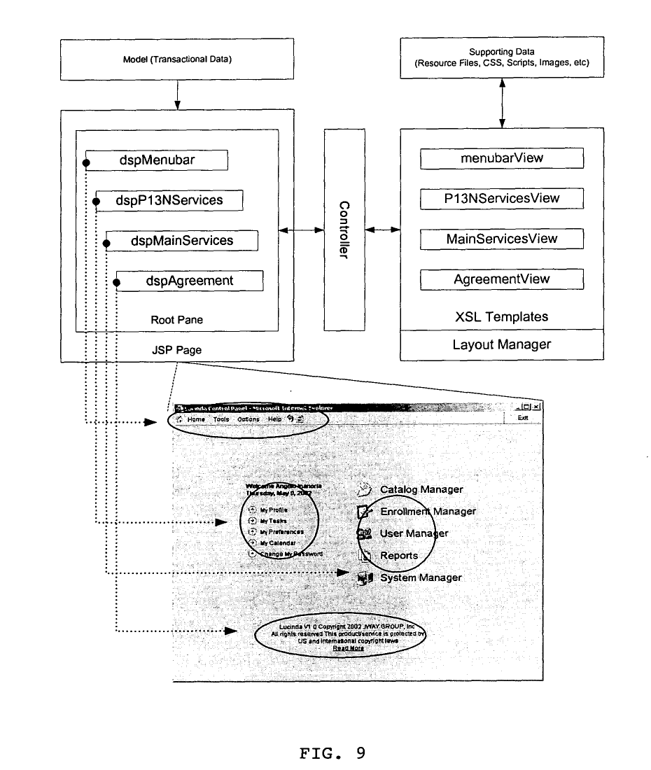

FIG. 9 illustrates how four distinct user interface objects (XUIOs) in the JSP page correspond to different components or services of the web application model and are used to communicate with the Controller. The Controller delegates rendering the appropriate components and communicates with the Layout Manager for executing a selected layout algorithm for the response. The Controller also handles rendering decisions based on the communicated information. The XUIOs can be as course-grained or as fine-grained as needed. They can be as big as a whole page or as small as a single UI component such as a button or textbox. They can be embedded within each other or can be independently controlled by multiple controllers.

The Controller uses one of the strongest attributes of an Object Oriented programming language wherein the pattern of polymorphism is applied. In a typical web application, the process of applying dynamic-ness to pages is achieved by creating importable code components and templates and thereby swapping these components and templates depending on the nature of the request. This is achieved through the use of programming controls such as If-Else and Switch-Case. The invention applies a different approach in creating dynamic screens for dynamic web applications. The preferred method is achieved through the application of polymorphic behavior in XSL without the use of heavyweight programming language such as Java. It passes a dynamic mode value to an XSL template wherein the dynamic value is either created through an XSL variable or created by using Java extensions in XSL where the value is either pulled from a session variable residing in cache or parsed from the XML fragment being passed to the Controller. In the manner described above, the polymorphic approach in delegating control to the proper component template provides a robust and highly flexible system. This type of system facilitates the ease of management of such components and the ability to scale without revising or re-architecting the current system.

Layout Manager

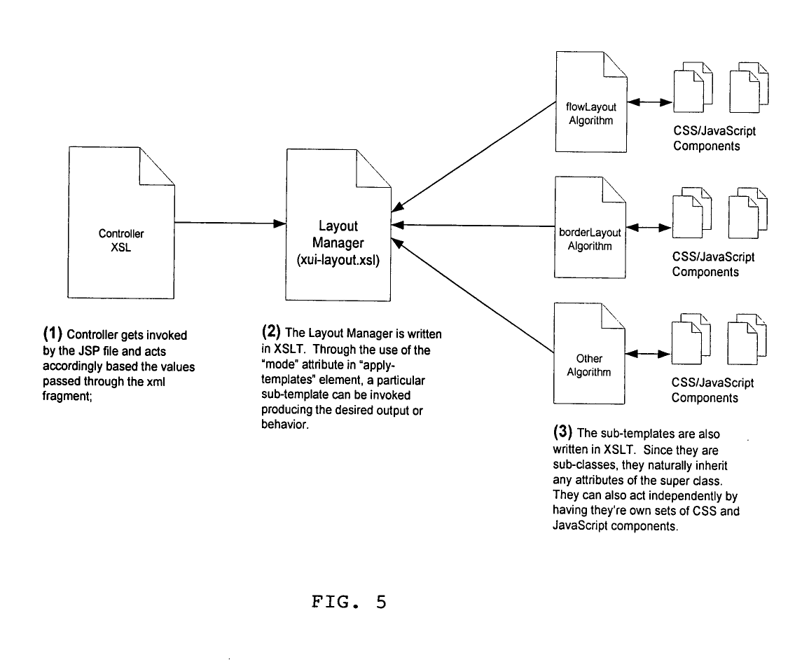

As shown in FIG. 5, the Layout Manager package consists of a master template (xui-layout.xsl) and a plurality of templates for each supported layout algorithm. The master template is exposed to the Controller as the xui-layout.xsl template; all of its contents by default are exposed to the Controller by way of importation through the xsl:import element. The xui-layout.xsl template contains other templates that are responsible for executing the different layout algorithms. For example, the XUI Layout Manager supports the following layout algorithms:

FlowLayout (default)—lays out the components inside a container from left to right as they are defined hierarchically within the document.

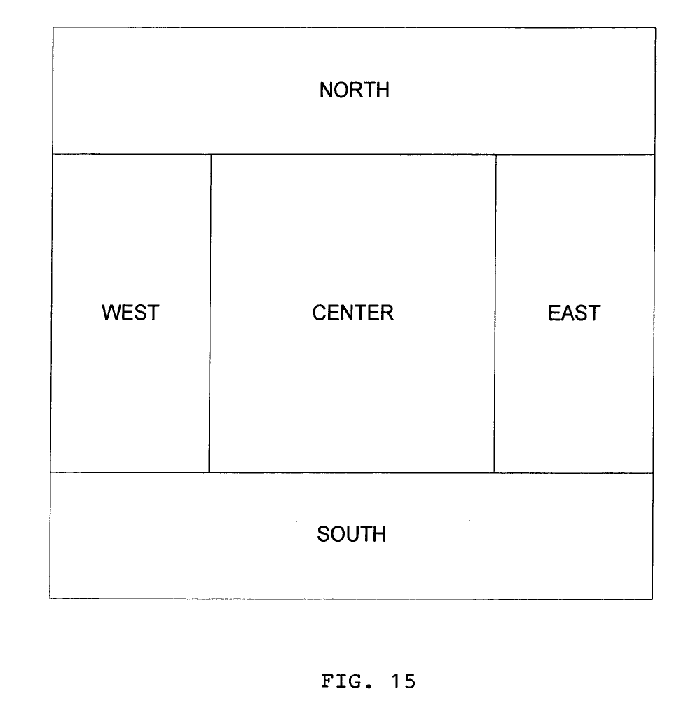

BorderLayout—Defines five specific containers which are given distinct geographic identifiers such as NORTH, SOUTH, WEST, EAST, and CENTER. Each of these containers can container other containers and component by declaring their positions through such geographic identifiers. For instance, a button component can appear inside the NORTH container by setting its “layout” attribute to “NORTH”. An example of these BorderLayout containers is shown in FIG. 15.

The Layout Manager uses the same polymorphic pattern wherein it determines which layout algorithm template is to be used by parsing the “layout” attribute within the “xpanel” element. The value of the “layout” attribute is then passed to the “mode” attribute of the apply-templates element within the XSL so that the appropriate layout algorithm can be called.

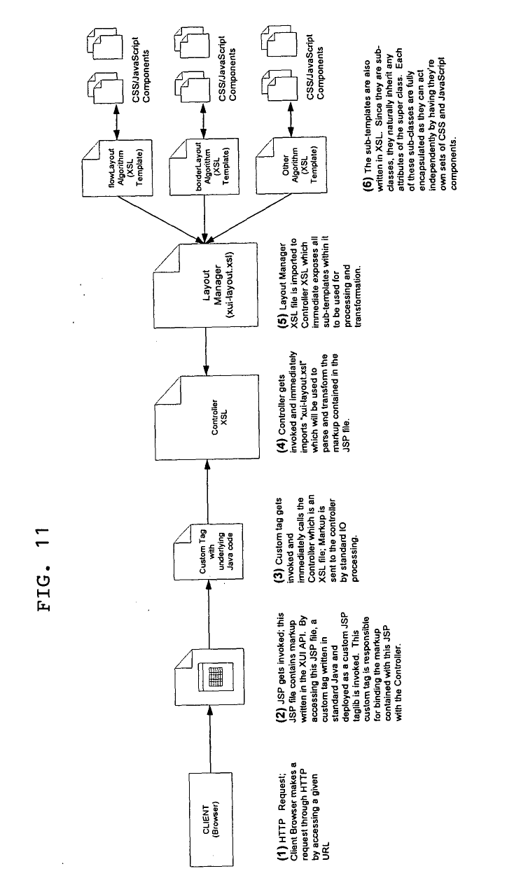

In FIG. 11, the logic flow for invoking the Layout Manager is illustrated. Upon receiving the HTTP request from the client user, the JSP file is invoked and a custom tag written in the file invokes the Controller. The Controller imports the template for and delegates control to the Layout Manager to parse and transform the markup information contained in the JSP file. The Layout Manager then delegates control to the appropriate sub-template for the execution of the selected layout algorithm, which can then import the encapsulated CSS or JavaScript components. The Layout Manager uses one of the strongest attributes of an Object Oriented programming language wherein the pattern of polymorphism is applied. In a typical web application, the process of applying dynamic-ness to pages is achieved by creating importable scripts, stylesheets and templates and thereby swapping these resources and templates depending on the nature of the request. This is achieved through the use of less flexible programming controls such as If-Else and Switch-Case. In the invention, a more flexible and powerful approach is used to obtain polymorphic behavior in the XSL without the use of heavyweight programming languages such as Java.

The following are examples of how the pattern of polymorphism is achieved by manipulating the “layout” attribute of the component. Whatever the value of this attribute is, it is ultimately passed to the Layout Manager for the proper positioning of the components. Hence, the execution of the layout algorithm is fully delegated to the Layout Manager by manipulating the contents of the “layout” attribute.

### EXAMPLE 1

The following “xpanel” is to have the default “flowLayout” algorithm with the absence of the “layout” attribute:

<xpanel opaque=“true” name=“standard”>

### EXAMPLE 2

The following “xpanel” is to have the default “flowLayout” algorithm with the existence of the “layout” attribute, but the value is left blank:

<xpanel opaque=“true” name=“standard” layout=” ”>

### EXAMPLE 3

The following “xpanel” is to have the default “flowLayout” algorithm with the existence of the “layout” attribute, but the value is an unrecognized value:

<xpanel opaque=“true” name=“standard” layout=“foo”>

### EXAMPLE 4

The following “xpanel” is to have default “flowLayout” layout algorithm through an explicit declaration of the desired layout.

<xpanel opaque=“true” name=“standard” layout=“flowLayout”>

### EXAMPLE 5

The following “xpanel” is to have the “borderLayout” layout algorithm as explicitly declared in the “layout” attribute:

<xpanel opaque=“true” name=“standard” layout=“borderLayout”>

As mentioned, the effect of polymorphism is achieved by the Layout Manager wherein only template call is made instead of the lengthy and non-flexible approach of using if-else or choose-when statements. In the manner described above, the polymorphic approach in delegating control to the proper component template provides a robust and highly flexible system. This type of system facilitates the ease of management of such components and the ability to scale without revising or re-architecting the current system. The following examples further illustrate how polymorphism is used to apply different modalities by creating one template call.

### EXAMPLE 1

The following example illustrates how custom tags written in SAXUI are structured and organized within a JSP file. In this example, there are two panels defined where in “panel_{—}1” is to be laid out using the default “flowLayout” layout algorithm; whereas “panel_{—}2” is to be laid out using the “BorderLayout” layout algorithm:

<%@ taglib uri=“http://www.jway.com/xui-1.0” prefix=“xui” %>
<xui:style outputMethod=“HTML”>

<xframe name=“main” lookandfeel=“MSWindows”>

<xcontentpane>

<xpanel name=“panel_1” layout=“flowLayout”>

. . . more code here

</xpanel>
<xpanel name=“panel_2” layout=“borderLayout”>

. . . more code here

</xpanel>

</xcontentpane>

</xframe>

</xui:style>

### EXAMPLE 2

The following example illustrates how the Controller, which is being invoked by the JSP file, shows that the xui-layout.xsl is being imported; once this file is imported, the template with the match value of “//xpanel” and mode value of “setLayout” can be called from the Controller. Once this template is called, the rest of the processing is fully delegated to the Layout Manager represented by the file xui-layout.xsl:

<?xml version=“1.0” encoding=“UTF-8”?>
<xsl:stylesheet version=“1.0” xmlns:xsl=“http://www.w3.org/1999/XSL/Transform”
xmlns:fo=“http://www.w3.org/1999/XSL/Format”>
<xsl:import href=“xui-layout.xsl” />
. . . more xsl imports here
<xsl:template match=“/”>

<xsl:apply-templates match=“//xpanel” mode=“setLayout”/>
. . . more xsl code here

</xsl:template>
</xsl:stylesheet>

### EXAMPLE 3

This is the Layout Manager which is a separate XSL file named xui-layout.xsl imported by the Controller XSL (note that once this file is imported into another template, all templates herein are exposed to and can be called by the importing template). In this example, the value of the attribute “layout”, represented by the XPath expression “self: node( )/@layout”, of any “xpanel” element found inside the source document is assigned to the variable named “layout”. This variable is then passed to the “mode” attribute so that the apply-templates element will call the appropriate template based on the desired mode. If the desired mode is not found, the default layout algorithm is applied:

<?xml version=“1.0” encoding=“UTF-8”?>
<xsl:stylesheet version=“1.0”
xmlns:xsl=“http://www.w3.org/1999/XSL/Transform”
xmlns:fo=“http://www.w3.org/1999/XSL/Format”>
<xsl:template match=“//xpanel” mode=“setLayout”>

<xsl:variable name=“layout” value=“self: :node () /@layout” />
<xsl:apply-templates match=“node ()” mode=“{$layout}” />

</xsl:template>
<xsl:template match=“node ()” mode=“flowLayout”>

. . .

</xsl:template>
<xsl:template match=“node ()” mode=“borderLayout”>
</xsl:template>

. . . more templates here for other layout algorithms

</xsl:stylesheet>

Component Manager

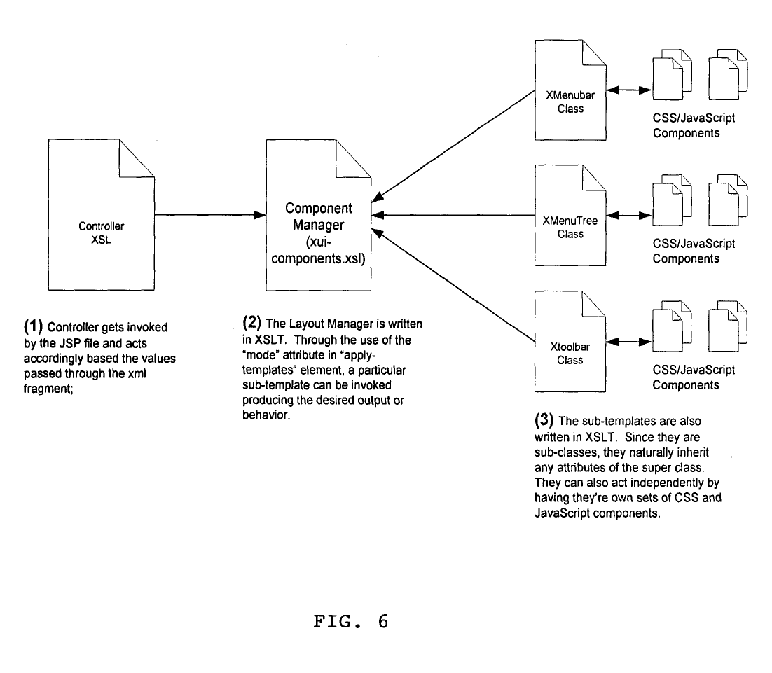

The Component Manager determines which XSL component templates are to be used to generate the desired GUI component. Each corresponding template for each component is ultimately responsible for rendering the component. They are also responsible for binding the appropriate scripts and stylesheets for the given component. As shown in FIG. 6, the Component Manager is invoked by the Controller and in turn delegates control to the appropriate sub-template for the rendering of the specified GUI components. As described previously, the Component Manager uses the attributes of the Object Oriented programming language to obtain polymorphic behavior in the GUI components.

As mentioned earlier, each GUI component is of class type “XComponent”. Instead of creating multiple, named XSL templates for each component, an abstract template is created having the same value in the “match” attribute but different mode values. For example, the following declaration is intended to render a menutree:

<xcomponent name=“mymenutree” class=“XMenutree”/>

The following declaration is intended to render a tabbed pane:

<xcomponent name=“mytabbedpane” class=“XTabbedPane”/>

Both of the elements above use the same element named “xcomponent”; both will be handled the same by the Controller but will be delegated to a particular XSL template based on the value of the class as defined above. When this information is passed to the Controller, the Controller takes the literal string contained in the “class” attribute and then passing it to the “mode” attribute of the <xsl:apply-templates> element creating a dynamic template application without the use of the typical programming controls such as if-else or switch-case statements. Thus, the effect of swapping templates through polymorphism is achieved within a declarative language such as XSL. For example:

<xsl:variable name=“componentClass” value=“self::node( )/@class”/>

<xsl:apply-templates match=“node( )” mode=”{$componentclass}”/>

The preceding example shows how the effect of polymorphism can be achieved in XSL. In the first line, the value of the attribute “class”, represented by the XPath expression “self: node( )/@class” of the “xcomponent” element is assigned to the variable named “componentClass”. This variable is then passed to the “mode” attribute so that the apply-templates element will call the appropriate template based on the desired mode. If the desired mode is not found, a null-pointer will be returned since the desired resource is not found. In the manner described above, the polymorphic approach in delegating control to the proper component template provides a robust and highly flexible system. This type of system facilitates the ease of management of such components and the ability to scale without revising or re-architecting the current system.

A more complete version of the example above is as follows. This is the calling JSP file embedded with SAXUIs where there are two components are defined inside to different panels. The first component named “menu_{—}1” is to be instantiated from the XMenubar class; the second component named “tabbedpane_{—}1” is to be instantiated from the XTabbedPane class:

<%@ taglib uri=“http://www.jway.com/xui-1.0” prefix=“xui” %>
<xui:style outputMethod=“HTML”>

<xframe name=“main” lookandfeel=“MSWindows”>

<xcontentpane>

<xpanel name=“panel_1”>

<xcomponent name=“menu_1” class=“XMenubar” />

</xpanel>
<xpanel name=“panel_2”>

<xcomponent name=“tabbedpane_1” class=“XTabbedpane” />

</xpanel>

</xcontentpane>

</xframe>

</xui:style>

This is the Controller XSL being invoked by the JSP file showing that the xui-layout.xsl is being imported; once this file is imported, the template with the match value of “//xpanel” and mode value of “setLayout” can be called from the Controller. Once this template is called, the rest of the processing is fully delegated to the Layout Manager represented by the file xui-layout.xsl:

<?xml version=“1.0” encoding=“UTF-8”?>
<xsl:stylesheet version=“1.0”
xmlns:xsl=“http://www.w3 .org/1999/XSL/Transform”
xmlns:fo=“http://www.w3.org/1999/XSL/Format”>
<xsl:import href=“xui-components.xsl” />
. . . more xsl imports here
<xsl:template match=“/”>

<xsl:apply-templates match=“//xcomponent” mode=“getComponents” />
. . . more xsl processing here

</xsl:template>
</xsl:stylesheet>

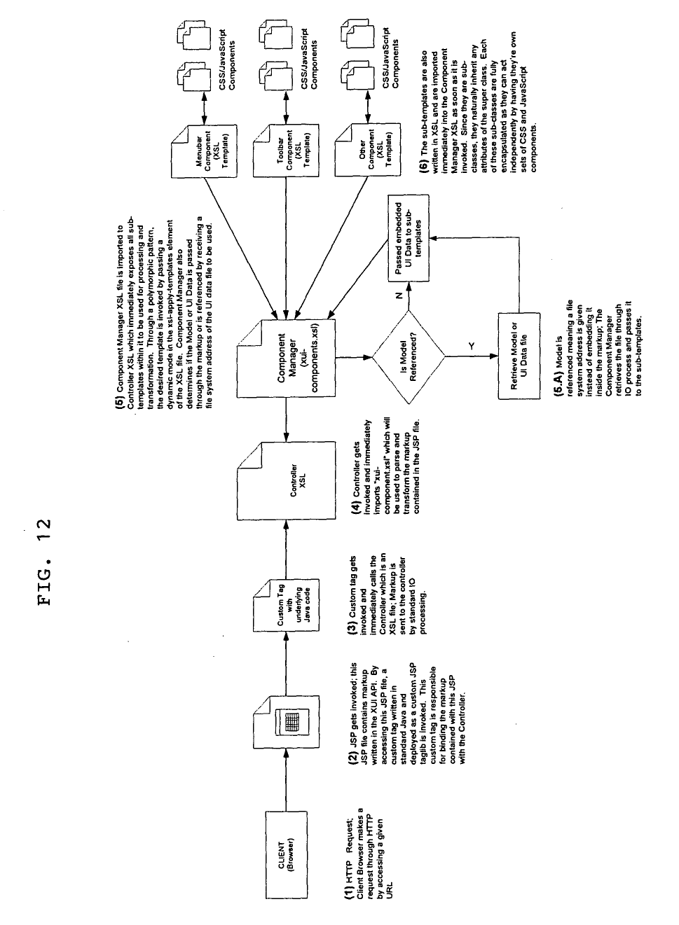

In FIG. 12, the logic flow for invoking the Layout Manager is illustrated. Upon receiving the HTTP request from the client user, the JSP file is invoked and a custom tag written in the file invokes the Controller. The Controller invokes the template for the Component Manager to parse and transform the markup information contained in the JSP file. The Component Manager is a separate XSL file named xui-components.xsl imported by the Controller XSL (note that once this file is imported into another template, all templates herein are exposed to and can be called by the importing template). Through the polymorphic pattern, the desired template is invoked by passing a dynamic mode in the xsl-apply-template element of the XSL file. The Component Manager also determines if Business Model data or UI data is referenced in the markup information. The Component Manager retrieves the Model or UI data through the I/O process and passes it to the GUI component sub-templates where it will appear.

In the following example, the value of the attribute “class”, represented by the XPath expression “self::node( )/@class”, of any “xcomponent” element found inside the source document is assigned to the variable named “componentClass”. This variable is then passed to the “mode” attribute so that the apply-templates element will call the appropriate template based on the desired mode. If the desired mode is not found, a null-pointer will be returned since the desired resource is not found:

<?xml version=“1.0” encoding=“UTF-8”?>
<xsl:stylesheet version=“1.0”
xmlns:xsl=“http://www.w3.org/1999/XSL/Transform”
xmlns:fo=“http://www.w3.org/1999/XSL/Format”>
<xsl:template match=“//component” mode=“setLayout”>

<xsl:variable name=“componentClass” value=“self: :node () /@class” />
<xsl:apply-templates match=“node ()” mode=“{$componentClass}” />

</xsl:template>
<xsl:template match=“node ()” mode=“XMenu”>

. . .

</xsl:template>
<xsl:template match=“node ()” mode=“XMenubar”>

. . .

</xsl:template>
<xsl:template match=“node of ()” mode=“XToolbar”>

. . .

</xsl:template>
<xsl:template match=“node ()” mode=“XTabbedpane”>

. . .

</xsl:template>

. . . more xsl templates here for other components

</xsl:stylesheet>

Application (Model or XUI) Data

The Model or XUI Data pertains to any data used for processing containers, components, and other resources within the XUI framework. Most of XUI Data is used in with components as they need data to be used as labels for example. Data can come as different forms. For example, some XUI data are preformatted in a structured XML document with an associated XML schema document which formally describes the grammar as to how the document should be structured. It uses embeddable data sets wherein data to be used by GUI components can be created in a separate file which can then be embedded by URI reference inside component declarations. By the same token, structured data sets, conforming with the same schema can be literally and physically embedded inside the <xcomponent> opening and closing tags and then passed to the controller and GUI Factory for further parsing and processing.

The following example illustrates how UI data can either be embedded by reference or can be embedded by manner of hard-coding the actual structure data set. The first xcomponent named “menu_{—}1” will use an external data file as referenced in the “xuidata” attribute. This structured data set will then be passed to the Controller and the GUI Factory for parsing and processing. The second xcomponent named “tabbedpane_{—}1” contains a physically embedded structure data set. The same effect will occur wherein this data set will be passed to the Controller and the GUI Factory for parsing and processing.

<%@taglib uri=“http://www.jway.com/xui-1.0” prefix=“xui” %>
<xui:style outputMethod=“HTML”>

<xframe name=“main” lookandfeel=“MSWindows”>

<xcontentpane>

<xpanel name=“panel_1”>

<xcomponent name=“menu_1” class=“XMenubar” xuidata=“menu_1.xml”

/>

</xpanel>
<xpanel name=“panel_2”>

<xcomponent name=“tabbedpane_1” class=“XTabbedpane”>

<xtab name=“tab_1” label=“General” >

. . . more content here

/xtab>
<xtab name=“tab_2” label=“Properties” >

. . . more content here

</xtab>
<xtab name=“tab_3” label=“Notes” >

. . . more content here

/xtab>

</xcomponent>

</xpanel>

</xcontentpane>

</xframe>

</xui:style>

The following is an example of the external data file as referenced by the xcomponent named “menu_{—}1”. This file is named “menu_{—}1.xml” which is a well-formed XML document. It is also a valid XML document as it conforms and validated by the XML schema document name “menu.xsd” as defined in the “xsi:noNamespaceSchemaLocation” attribute of the root element named “xui-data”:

<?xml version=“1.0” encoding=“UTF-8”?>
<xui-data xmlns:xsi=“http://www.w3.org/2001/XMLSchema-instance”
xsi:noNamespaceSchemaLocation=“menu.xsd”>

<menu label=“File”>

<menu-item label=“Open” />
<menu-item label=“Save” />
<menu-item label=“Exit” />

</menu>
<menu label=“Edit”>

<menu-item label=“Cut” />
<menu-item label=“Copy” />
<menu-item label=“Paste” />

</menu>

</xui-data>

Localized Content Manager (LCM)

The XUI Framework also includes a Localized Content Manager (LCM) wherein its primary goal is to organize and manage the rendering of internationalized assets such as labels and images by utilizing a markup language such as XML for the storage and definition of such assets. It also provides a web-based interface for the management of such assets. From this interface, a user with the proper privileges can view, add (upload), delete, and update a given asset. Localized assets also include CSS files, Script files and other locale specific configuration or descriptor files.

A few of the major assets that the LCM handles are localized UI data (labels), transactional or business data, and images. For UI data or labels, the actual assets are stored in XML files where the structure conforms to industry standards such as TMX or XLIFF. Storing internationalized labels in XML format facilitates the ease of use and management for multi-lingual characters specially double-byte characters for Asian languages since XML's native encoding is Unicode which can handle double-byte characters by using UTF-16 encoding. The present invention does not rely on the internationalization and localization feature inherently found in the Java language itself. By doing so, the portability of the framework is well kept wherein an implementation within a J2EE environment can be ported to another environment such as NET from Microsoft Corp. without rebuilding the internationalization feature of the system.

For images and other media, descriptors of such assets are stored in XML files called MMX (Multi Media Exchange) format. The actual media assets can be stored in the file system or a relational database with physical addresses described within the MMX descriptor file.

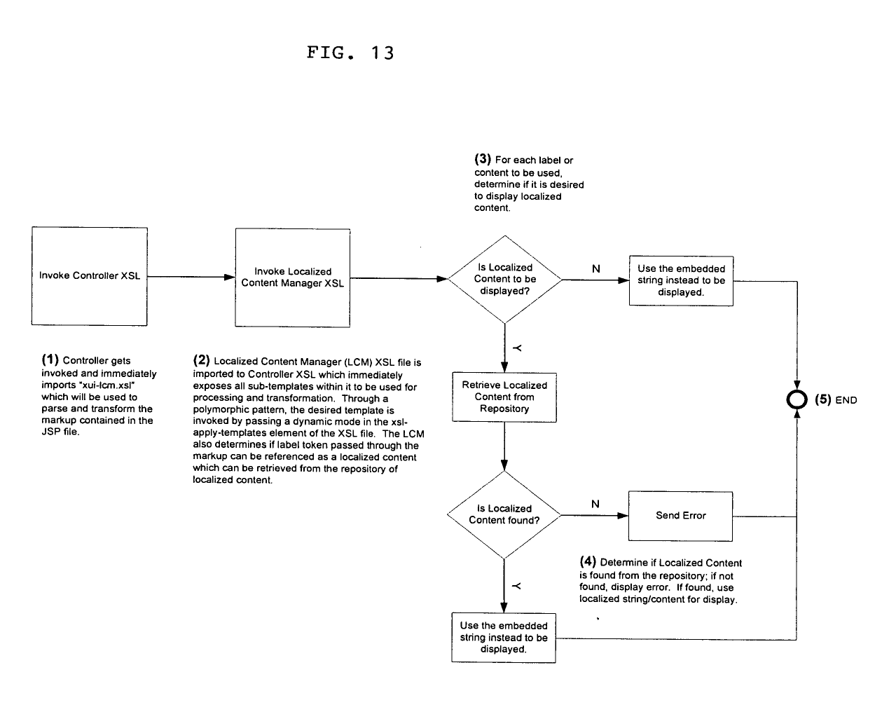

Referring to FIG. 13, the LCM is invoked by the Controller which imports xui-lcm.xsl to parse and transform the markup information contained in the JSP file. This immediately exposes all sub-templates within it to be used for processing and transformation. Through the polymorphic pattern, the desired template is invoked by passing a dynamic mode in the xsl-apply-templates element of the XSL file. The LCM also determines if label tokens passed through the markup information reference localized content to be retrieved from the repository of localized content. The LCM is responsible for rendering these localized assets if requested by any of the components. When a component encounters an XUI Localized Content (XLC) prefix from a XUIDataset identified by the prefix xlc, the rendering is delegated to the LCM by passing to it the requested internationalized asset identifier and the preferred locale or language in the form of language-territory combination such as “en_US” for English-United States or “ja_JP” for Japanese-Japan. The xlc prefix is bound to the namespace: http://www.jway.com/xui-1.0/i18n. For example, the controller may encounter an LCM token such as xlc:title as shown below:

<menu-item label=“xlc:title”/>

Control is delegated to the LCM to find the localized version of this identifier by sorting through the assets and displaying the proper asset depending on the selected locale or language. This manner of handling internationalization from the component level gives the fine-grain control as to which labels should be or can be displayed with internationalized label. If a certain label does not have an equivalent internationalized label, the developer has two choices in terms of handling the situation. First, the developer has the choice of embedding the actual label as the value of the “label” attribute of the component. With the absence of the xlc prefix, the LCM will render the label as a literal string. For example, the developer can code the following to render the literal string “Title”:

<xui:menu-item label=“Title”/>

The following is another example of how an XUI data set may look like with mixed content where some labels are internationalized and some are not. The first set of “menu” data set contains elements with values in the label attributes intended to be rendered in locale-specific manner given the fact that they have the xlc prefix before their names. The second “menu” data set's labels will be rendered as they are written given the absence of the xlc prefix before their names:

<xui-data xmlns:xsi=“http://www.w3.org/2001/XMLSchema-instance”
xsi:noNamespaceSchemaLacation=“menu.xsd”
xmlns:xls=“http://www.jway.com/xui-1.0/i18n”>

<menu label=“xlc:File”>

<menu-item label=“xlc:Open” />
<menu-item label=“xlc:Save” />
<menu-item label=“xlc:Exit” />

</menu>
<menu label=“Edit”>

<menu-item label=“Cut” />
<menu-item label=“Copy” />
<menu-item label=“Paste” />

</menu>

Rendering behavior of each component is changed through information communicated by the UI data elements and other environmental variables that is passed to all resources coming all the way from the top-most container. In this case, the root container has communicated to the controller that the preferred language is Japanese. The Controller then goes into action by shifting the encoding information, which is then inherited by each corresponding views. If for some instance the developer mistakenly enters an identifier without real internationalized label stored in the repository that can support the rendering, then a null pointer will be returned since the resource that is being requested is not available.

Look-and-Feel Manager

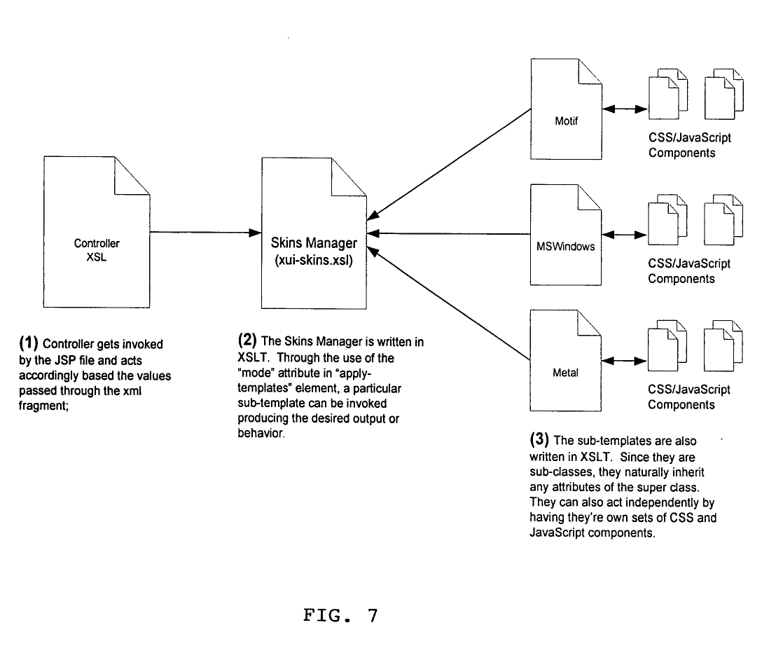

The XUI Framework includes a Look-and-Feel Manager to apply a selected look-and-feel type to the view presentation. As shown in FIG. 7, the Look-and-Feel Manager is invoked by the Controller and delegates control (through polymorphism) to its look-and-feel sub-templates to execute the layout algorithm.

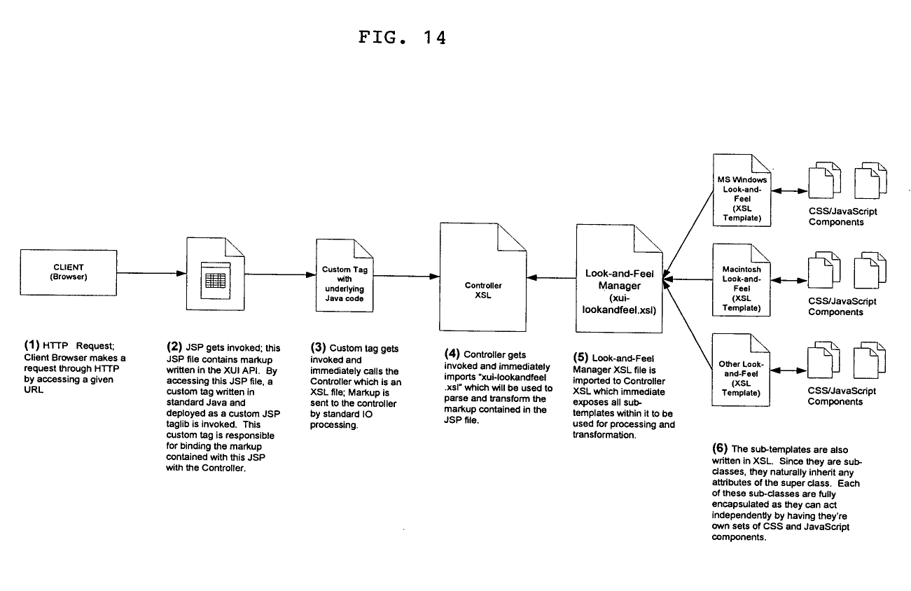

FIG. 14 illustrates the logic flow to invoke the Look-and-Feel Manager. Upon receipt of the HTTP request, the Controller XSL is invoked by the JSP file which imports xui-lookandfeel.xsl to parse and transform the markup information contained in the JSP file. This immediately exposes all sub-templates within it to be used for processing and transformation. The template having the mode value of “setLookandFeel” resides inside the “xui-lookandfeel.xsl” file. Each of these templates have a unique mode value so that when the xsl:apply-templates element is executed, it will search through the present templates including all imported templates and invoke the template having the desired mode value. Once this template is called, the rest of the processing is fully delegated to the Layout Manager represented by the template having the “setLookandFeel” mode residing inside the file xui-lookandfeel.xsl. The ability of the xsl:apply-templates element to search through the present template and all imported templates is inherent to XSL The following example illustrates how a specific template having a look-and-feel emulating the Microsoft Windows(TM) environment is invoked dynamically. A variable named “lookandfeel” is created by using the built-in xsl:variable element and loading it with the value of “MSWindows”. In the subsequent parts of the code, there are several templates having a similar “match” attribute but having distinct values in the “mode” attribute. Having the same “match” value is similar to having the same method name. In this instance, by executing the xsl:apply-templates having similar value for its “select” attribute as it is with the value of the “match” attribute of each templates, each of these templates are “targets” for template execution. But having a particular value for the “mode” attribute of the xsl:apply-templates element, it will selectively execute the template having the same value in the “mode” attribute. In this instance, the template having the “MSWindows” value for its “mode” attribute will be invoked. Different datasets can then be passed to these templates so that they can be used accordingly. The business data from the Business Layer can thus be passed to a particular template without regard to the look-and-feel that will be used to render the view of the data. A code version for this example is as follows:

<?xml version=“1.0” encoding=“UTF-8”?>
<xsl:stylesheet version=“1.0”
xmlns:xsl=“http://www.w3.org/1999/XSL/Transform”
xmlns:fo“http://www.w3.org/1999/XSL/Format”>
xml:template match=“/”>

<xsl:variable name=“lookandfeel” select=“MSWindows”/>
<xsl:apply-templates select=“node ()” mode=“{$lookandfeel}” />

</xsl:template>
<xsl:template match=“node ()” mode=“MSWindows”>

. . .

</xsl:template>
<xsl:template match=“node ()” mode=“Metal”>

. . .

</xsl:template>
<xsl:template match=“node ()” mode=“Motif”>

. . .

</xsl:template>
<xsl:template match=“node ()” made=“Macintosh”>

. . .

</xsl:template>
. . . more templates here for other look-and-feel
</xsl:stylesheet>

Event Manager

GUIs written in any language such as Java Swing or MFC are typically event driven. They sit idle and dormant until an event occurs. An event handler then goes to work and responds to the event. In XUI, events can occur in the component level or the container level. It is important to understand that events are not programmatically created activities but rather typical, natural and expected occurrences within the screen. Without events, the application screen will not do anything and will remain idle until a certain event happens. It is also typical to fire an event by determining if the screen has been idle for a certain period of time. For example, a window can automatically refresh after 1 minute of idleness which triggers the load event. Some examples of events are clicking the mouse, moving the cursor over a component, opening a window, loading a page within a window, scrolling the scrollbar, etc.

By default, events that occur from the component level are propagated to its parents and ancestor containers, and all the way to the top-level container. An event can be propagated up to a certain level of container or it can be handled entirely within the affected component. Event propagation is determined by setting the handle-event attribute of the component. For example:

handle-event=“self”—Handles the event entirely within the component

handle-event=“parent”—Handles the event within the component and propagated up to the parent component.

handle-event=“ancestor”—Handles the event within the component and propagated to its parent and its ancestors all the way to the top-level container.

Canceling the propagation of an event is delegated to the client browser by invoking the cancelBubble( ) method in Javascript.

In summary, the present invention provides a method for web application development that enables rich GUIs to be built using the XUI Framework for creating a number of complementary, interacting GUI-managing components written in simple declarative format and coordinating their functions through a Controller in the Extended-Model-View-Controller approach. The XUI Framework employs reusable and extendable or extensible user interface (UI) content objects exhibiting polymorphic behavior. The view management components can be formulated in simple XML, XSL, DHTML, XHTML, and HTML statements, which can readily be handled by JavaScript and CSS for client-side processing, and XML technologies and Java Technologies for server-side processing, thereby avoiding the use of heavyweight technologies such as Java Swing and AWT. The GUI-managing components are designed to create GUIs that have a “deliberate kinship” to existing GUI development environments in order to emulate the techniques, patterns, conventions and standards familiar to a broad base of users. Web applications can be developed with a set of rich GUIs that naturally produces a similar user experience as found in conventional client or desktop applications, while providing a huge improvement in performance, flexibility, scalability and manageability of the web application, and large savings in development cost.

While certain preferred embodiments of the invention have been described, it is intended that all embodiments, variations, and modifications thereof within the spirit and scope of the disclosed principles be deemed included within the present invention, as defined in the appended claims.

1. A method for web application development comprising:
providing an extensible user interface (XUI) framework for developing modular and extensible GUI-managing components residing in a view presentation layer separate from a business logic layer for a given web application, wherein the GUI-managing components are written in simple declarative format referencing predefined templates to be invoked for handling GUI components to be incorporated in a view of a requested web page, and
using an Extended-Model-View-Controller (XMVC) pattern of operation of the view presentation layer wherein an XMVC Controller coordinates the functions of the GUI-managing components by invoking the referenced templates for handling the GUI components in the view presentation layer and generating a view of the requested web page in conjunction with application data provided by the business logic layer.

2. A method according to claim 1, wherein the XMVC Controller is invoked by a user request for a web page and in turn invokes the GUI-managing components to parse information contained in a corresponding web application file for the requested web page in order to determine the templates and sub-templates thereof to be invoked for handling GUI components in the view presentation layer.

3. A method according to claim 1, wherein the XMVC Controller invokes the GUI-managing components by importing respective templates and sub-templates thereof, wherein each template has a mode value which is set by mode information contained in the web application file for the requested web page.

4. A method according to claim 1, wherein a Layout Manager is a component of the GUI-managing components and has the responsibility of positioning and shaping GUI components in a view of a web page.

5. A method according to claim 1, wherein a Component Manager is a component of the GUI-managing components and has the responsibility of organizing and invoking each desired GUI component to be included in a view of a web page.

6. A method according to claim 1, wherein a Localized Content Manager is a component of the GUI-managing components and has the responsibility of organizing and rendering localized labels and images for GUI components to be included in a view of a web page.

7. A method according to claim 1, wherein a Look-and-Feel Manager is a component of the GUI-managing components and has the responsibility of organizing and rendering a desired look-and-feel format for presenting GUI components in a view of a web page.

8. A method according to claim 1, wherein an Event Manager is a component of the GUI-managing components and has the responsibility for determining and handling events for each desired GUI component in a view of a web page.

9. A method according to claim 2, wherein the GUI components are rendered by the GUI-managing components to exhibit polymorphic behavior through a hierarchical form of organization of the referenced templates and sub-templates.

10. A method according to claim 4, wherein the Layout Manager includes sub-templates for selected layout algorithms for positioning and shaping GUI components in a view of a web page.

11. A method according to claim 5, wherein the Component Manager includes sub-templates for stylesheets, scripts, and other GUI components in a view of a web page.

12. A method according to claim 6, wherein the Localized Content Manager includes sub-templates for localized images and labels to be used for GUI components in a view of a web page.

13. A method according to claim 7, wherein the Look and Feel Manager includes sub-templates for different look-and-feel formats to be used for GUI components in a view of a web page.

14. A method according to claim 8, wherein the Event Manager includes sub-templates for different event handlers for GUI components in a view of a web page.

15. A method according to claim 1, wherein said templates incorporate pre-defined GUI components designed to create “deliberate kinship” by emulating techniques, patterns, conventions and standards of conventional windowing environments.

16. An environment for web application development comprising:
an extensible user interface (XUI) framework for developing a number of modular and extensible GUI-managing components residing in a view presentation layer separate from a business logic layer for a given web application, wherein the GUI-managing components are written in simple declarative format referencing predefined templates to be invoked for handling GUI components to be incorporated in a view of a requested web page, and
an XMVC Controller for coordinating the functions of the GUI-managing components in an Extended-Model-View-Controller (XMVC) pattern of operation by invoking the referenced templates of the of the GUI-managing components and delegating control to the respective GUI-managing components for managing their respective functions for handling GUI components in the view presentation layer and generating a view of the requested web page in conjunction with application data provided by the business logic layer.

17. A web application development environment according to claim 16, wherein the XMVC Controller is invoked by a user request for a web page and in turn invokes the GUI-managing components to parse information contained in a corresponding web application file for the requested web page in order to determine the templates and sub-templates thereof to be invoked for handling GUI components in the view presentation layer.

18. A web application development environment according to claim 16, wherein the XMVC Controller invokes the GUI-managing components by importing respective templates and sub-templates thereof, and wherein each template has a mode value which is set by mode information contained in the web application file for the requested web page.

19. A web application development environment according to claim 16, wherein the GUI-managing components include a Layout Manager for positioning and shaping GUI components in a view of a web page, a Component Manager for organizing and invoking each desired GUI component to be included in a view of a web page, a Localized Content Manager for organizing and rendering localized labels and images for GUI components to be included in a view of a web page, a Look-and-Feel Manager for organizing and rendering a desired look-and-feel format for presenting GUI components in a view of a web page, and an Event Manager for determining and handling events for each desired GUI component in a view of a web page.

20. A web application development environment according to claim 16, wherein the GUI components are rendered by the GUI-managing components to exhibit polymorphic behavior through a hierarchical form of organization of the referenced templates and sub-templates.
